(19) United States
(12) Patent Application Publication
(10) Pub. No.: US 2026/0048689 A1
(43) Pub. Date: Feb. 19, 2026

(54) CUSHION ASSEMBLY

(71) Applicant: Lear Corporation, Southfield, MI (US)

(72) Inventors: Ashley BAISCH, Washington Township, MI (US); Daniel JOSEFSSON, Mullsjo (SE)

(21) Appl. No.: 18/806,769

(22) Filed: Aug. 16, 2024

(51) Int. Cl. B60N 2/56; B60N 2/70

(52) U.S. Cl. CPC B60N 2/5635; B60N 2/70

(57) ABSTRACT

A cushion assembly is provided with a cushion provided with a mesh member. The mesh member is provided with a set of filaments of polymeric material, wherein at least two members of the set of filaments are looped and bonded to each other. A fluid impermeable layer is attached to the cushion. The fluid impermeable layer is provided with an inlet and an outlet. The inlet and outlet are formed in a base surface or an occupant support surface of the cushion. A fluid actuator is attached to the inlet or the outlet. A retainer is connected to the fluid impermeable layer and the cushion, and the retainer extends into a fluid permeable region of the cushion between the inlet and the outlet.

### TECHNICAL FIELD

Various embodiments relate to cushion assemblies.

### BRIEF DESCRIPTION OF THE DRAWINGS

FIG. 1 is a perspective view of an example of a seat assembly including a filament mesh structure.

FIG. 2 is schematic view of an example of a manufacturing system for making the filament mesh structure.

FIG. 3 is a side partial section view of a cushion assembly of the seat assembly of FIG. 1, according to an embodiment.

FIG. 4 is a side partial section view of a cushion assembly of the seat assembly of FIG. 1, according to another embodiment.

FIG. 5 is a side partial section view of a cushion assembly of the seat assembly of FIG. 1, according to another embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first surface could be termed a second surface, and, similarly, a second surface could be termed a first surface, without departing from the scope of the various described embodiments. The first surface and the second surface are both surfaces, but they are not the same surface.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event].” depending on the context.

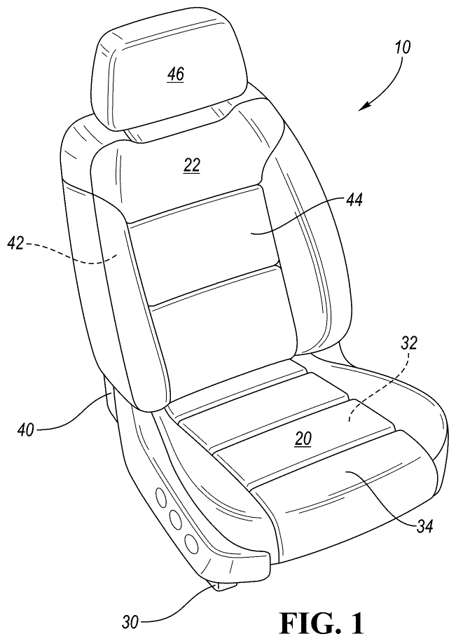

Referring to FIG. 1, an example of a seat assembly 10 is shown. In some embodiments, the seat assembly 10 is a vehicle seat assembly 10, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad as will be discussed in more detail below.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

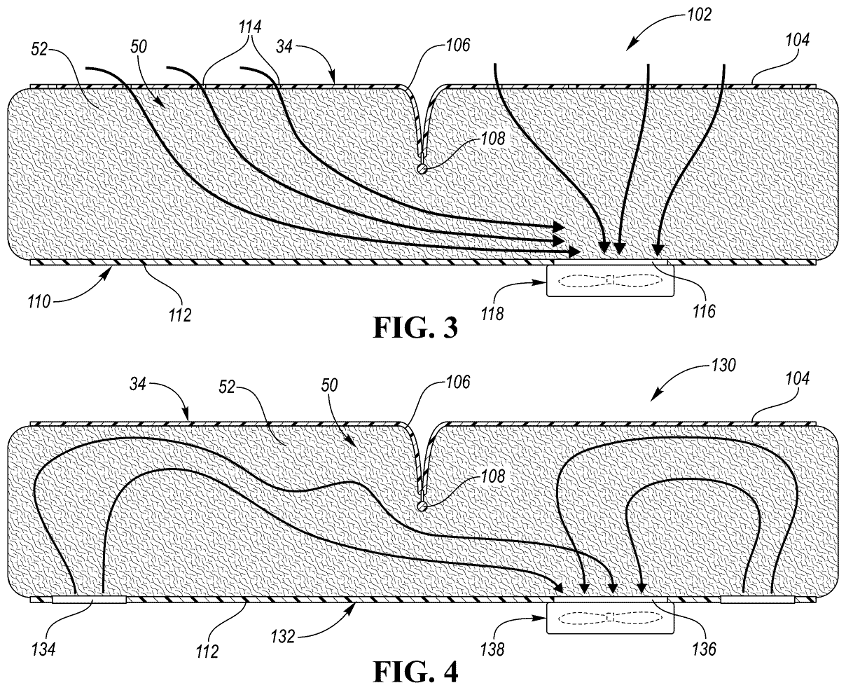

Referring to FIG. 3, an example of a cushion 50 is shown. The cushion in generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 3, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

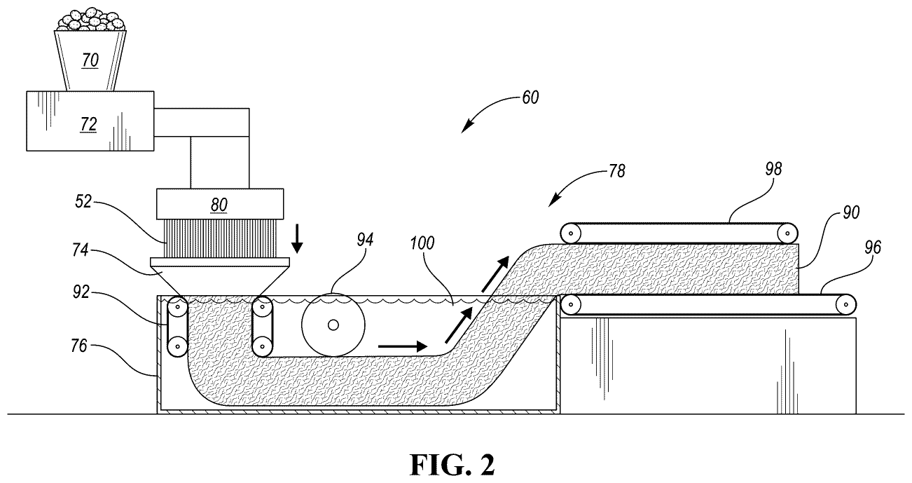

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments 52 may slide along the funnel 74 or an intervening sheet that is disposed on the funnel 74 as the filaments 52 move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid 100, such as water or a mixture of water and another fluid. The liquid 100 in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid 100 provides some buoyancy or resistance that can result in additional bending, curling, or looping of the filaments 52 adjacent to the surface of the liquid 100 or within the funnel 74 to further build the filament mesh structure 90. The liquid 100 also cools the filaments 52 when the filaments 52 are in the liquid 100. For instance, the liquid 100 cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid 100 and out of the liquid 100. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively, or in addition to, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting subsystem may be of any suitable type. For instance, the cutting subsystem may employ a blade, knife, hot knife, saw, fluid jet, or the like to cut the filaments 52 of the filament mesh structure 90 into a blank. The cutting subsystem may be used to shape or contour the blank. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments.

With reference again to FIG. 3, a cushion assembly 102 is illustrated, which includes the cushion 50. The cushion assembly 102 is designed to condition an open volume within the seat assembly 10 for comfort for a seated occupant. Such a design, or preconditioning, of the seat assembly 10, cushions the seated occupant while improving a thermal sensation to the seated occupant, and providing enhanced thermal uniformity. Although the filament mesh cushion 50 is illustrated and described, in some embodiments, the cushion 50 is formed from foam or a spacer fabric.

The cushion assembly 102 includes the trim cover 34 on an occupant support surface 104. The occupant support surface 104 is an outward surface of the cushion assembly 102 that is contacted by the occupant when seated upon the cushion assembly 102. In the depicted embodiment, the trim cover 34 may be formed with a join 106. The join 106 may be a seam, a trench, a fold, a weld, a trim channel, a retainer 108, or the like that is stitched, sewn, welded, glued, retained, fastened, tied down, or otherwise formed to attach the trim cover 34 to the cushion 50 at the join 106.

According to an embodiment, the trim cover 34 provides a trim cover layer, or an occupant support layer. The trim cover 34 may be formed from a fluid resistant layer, such as a fluid impermeable layer or a layer that resists fluid flow, such as air flow, through the material. The trim cover 34 may be formed from a fabric, leather, polymeric material, such as thermoplastic polyurethane (TPU) film, polyvinyl chloride (PVC) film, polyethylene, or the like. A barrier layer 110 is also provided on the cushion 50 and is spaced apart from the trim cover layer 34. The barrier layer 110 may be formed integrally with the trim cover layer 34. According to some embodiments, the trim cover layer 34 and the barrier layer 110 are bonded or sealed at intersections of the layers 34, 110 at peripheral ends (not shown) of the cushion 50.

The barrier layer 110 is disposed upon a base surface 112 of the cushion 50. The base surface 112 supports the cushion 50 upon the frame 30. The barrier layer 110 may also be formed from an air resistant layer, such as an air impermeable layer. Alternatively, the barrier layer 110 may be provided from a rigid seat pan or carrier substrate.

The porosity of the cushion 50 provides free flow paths of the fluid impermeable cushion 50. The retainer 108 extends only partially into the cushion 50 and cooperates with the trench 106 so that the trench 106 does not extend to the base layer 110. The trench 106 restricts a flow path of air in the cushion 50, but does not prevent air flow within the cushion 50 between the trench 106 and the base layer 110.

With the open body material of the cushion 50, volume under the trim cover 34 can be conditioned in a uniform way by pulling ambient air into the body, having vehicle and occupant movements provide pulsing of air volume and thereby an exchange of air or by pushing ambient or conditioned (heated or cooled) air into the mentioned volume.

Occupant energy equilibrium is one thermal target to provide comfort. By air exchange in an open structure material of the cushion 50, thermal equilibrium can be reached faster than in conventional systems. Conventional foam cushions hold residual energy for a long time, and to condition the occupant contact area, ventilation is typically through a permeable trim layer, with means of distribution provided by three-dimensional mesh inlays. These inlays cause material comfort differences across the contact surface, which are mitigated with the open volume conditioning of the cushion 50. Uniform conditioning is not possible in a “closed” foam, since conditioning is dependent on channels for vent distribution, and the foam body will still hold residual energy. An open volume with the mesh cushion 50 can be better conditioned as a uniform volume by providing designed air flows through this volume. Rapid equilibrium is reached by exchange of the air volume, and with a conditioned (heated or cooled) air stream into the system conditioning can be significantly improved, providing a much better uniformity than conventional systems, and has potential of reducing noise, reducing energy load and improving design flexibility for manufacturers and end users.

The trim layer 34 is provided with a plurality of inlets 114 formed through the trim cover 34 to permit a flow of fluid through the trim cover 34 at designated orientations. Although the trim layer 34 may be formed from an air impermeable material, the inlets 114 permit the trim layer 34 to be air permeable as defined by the inlets 114. The inlets 114 may be vents, ports, actuated, or the like.

The base layer 110 is provided with at least one outlet 116 formed through the base layer 110 to permit a flow of fluid through the base layer 110. To further assist fluid flow, and to direct the fluid flow, a fluid actuator, such as a fan assembly 118 is provided in the outlet 116 to direct the flow of air through the cushion 50. The fan assembly 118 is directed outward from the cushion assembly 102, thereby exhausting air from the cushion 50. Although the fan assembly 118 is illustrated and described, the fluid actuator may be a compressor, or the like.

In the exhaust orientation of the fan assembly 118, operation of the fan assembly 118 pulls external air through the inlets 114 in the trim layer 34, through the cushion 50, and out of the outlet 116 as depicted by the flow direction arrows. The open volume of the cushion 50 permits air to pass beneath the trench 106 and the retainer 108 from some of the inlets 114 to the outlet 116. Air is routed beneath the trench 106 without additional channels, outlets, fluid actuators, or the like. Such improvements increase efficiency and reduce noise and energy. The filaments 52 create turbulence to assist with heat transfer by convection within the cushion 50.

FIG. 4 illustrates a cushion assembly 130, which includes the cushion 50. The cushion assembly 130 is designed to condition an open volume within the seat assembly 10 for comfort for a seated occupant. Such a design, or preconditioning, of the seat assembly 10, cushions the seated occupant while improving a thermal sensation to the seated occupant, and providing enhanced thermal uniformity. Although the filament mesh cushion 50 is illustrated and described, in some embodiments, the cushion 50 is formed from foam or a spacer fabric.

The cushion assembly 130 includes the trim cover 34 on the occupant support surface 104 of the cushion assembly 130. In the depicted embodiment, the trim cover 34 is formed with the join 106, which is a seam, a trench, a fold, a weld, a trim channel, the retainer 108, or the like that is stitched, sewn, welded, glued, retained, fastened, tied down, or otherwise formed to attach the trim cover 34 to the cushion 50 at the join 106.

According to an embodiment, the trim cover 34 provides a trim cover layer, or an occupant support layer. The trim cover 34 may be formed from a fluid resistant layer, such as a fluid impermeable layer or a layer that resists fluid flow, such as air flow, through the material.

The trim cover 34 may be formed from a fabric, leather, polymeric material, such as thermoplastic polyurethane (TPU) film, polyvinyl chloride (PVC) film, polyethylene, or the like. A barrier layer 132 is also provided on the cushion 50 and is spaced apart from the trim cover layer 34. The barrier layer 132 may be formed integrally with the trim cover layer 34. According to some embodiments, the trim cover layer 34 and the barrier layer 132 are bonded or sealed at intersections of the layers 34, 132 at peripheral ends (not shown) of the cushion 50.

The barrier layer 132 is disposed upon the base surface 112 of the cushion 50. The base surface 112 supports the cushion 50 upon the frame 30. The barrier layer 132 may also be formed from an air resistant layer, such as an air impermeable layer. Alternatively, the barrier layer 132 may be provided from a rigid seat pan or carrier substrate.

The porosity of the cushion 50 provides free flow paths of the fluid impermeable cushion 50. The retainer 108 extends only partially into the cushion 50 and cooperates with the trench 106 so that the trench 106 does not extend to the base layer 132. The trench 106 restricts a flow path of air in the cushion 50, but does not prevent air flow within the cushion 50 between the trench 106 and the base layer 132.

The base layer 132 is provided with a plurality of inlets 134 formed through the based surface 112 to permit a flow of fluid through the base layer 132 at designated orientations. Although the base layer 132 may be formed from an air impermeable material, the inlets 134 permit the base layer 132 to be air permeable as defined by the inlets 134. The inlets 134 may be vents, ports, actuated, or the like.

The base layer 132 is provided with at least one outlet 136 formed through the base layer 132 to permit a flow of fluid through the base layer 132. To further assist fluid flow, and to direct the fluid flow, a fluid actuator, such as a fan assembly 138 is provided in the outlet 136 to direct the flow of air through the cushion 50. The fan assembly 138 is directed outward from the cushion assembly 130, thereby exhausting air from the cushion 50. Although the fan assembly 138 is illustrated and described, the fluid actuator may be a compressor, or the like.

In the exhaust orientation of the fan assembly 138, operation of the fan assembly 138 pulls external air through the inlets 134 in the base layer 132, through the cushion 50, and out of the outlet 136 as illustrated by the flow direction arrows. The open volume of the cushion 50 permits air to pass beneath the trench 106 and the retainer 108 from some of the inlets 134 to the outlet 136. Air is routed beneath the trench 106 without additional channels, outlets, fluid actuators, or the like. Such improvements increase efficiency and also reduce noise and energy. The filaments 52 create turbulence to assist with heat transfer by convection within the cushion 50.

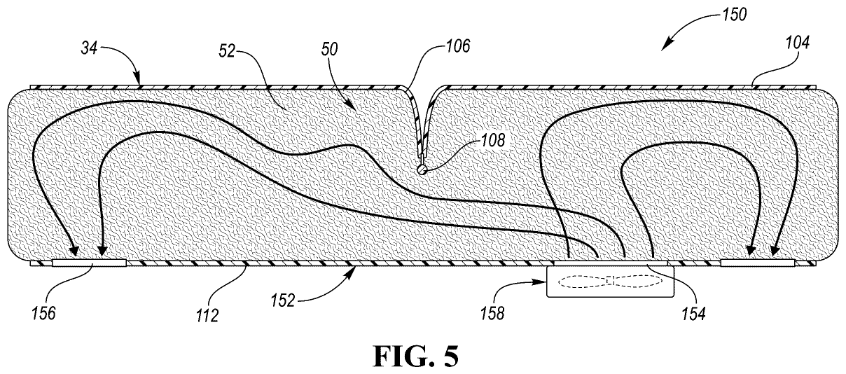

FIG. 5 illustrates a cushion assembly 150, which includes the cushion 50. The cushion assembly 150 is designed to condition an open volume within the seat assembly 10 for comfort for a seated occupant. Such a design, or preconditioning, of the seat assembly 10, cushions the seated occupant while improving a thermal sensation to the seated occupant, and providing enhanced thermal uniformity. Although the filament mesh cushion 50 is illustrated and described, in some embodiments, the cushion 50 is formed from foam or a spacer fabric.

The cushion assembly 150 includes the trim cover 34 on the occupant support surface 104 of the cushion assembly 150. In the depicted embodiment, the trim cover 34 is formed with the join 106, which is a seam, a trench, a fold, a weld, a trim channel, the retainer 108, or the like that is stitched, sewn, welded, glued, retained, fastened, tied down, or otherwise formed to attach the trim cover 34 to the cushion 50 at the join 106.

According to an embodiment, the trim cover 34 provides a trim cover layer, or an occupant support layer. The trim cover 34 may be formed from a fluid resistant layer, such as a fluid impermeable layer or a layer that resists fluid flow, such as air flow, through the material. The trim cover 34 may be formed from a fabric, leather, polymeric material, such as thermoplastic polyurethane (TPU) film, polyvinyl chloride (PVC) film, polyethylene, or the like. A barrier layer 152 is also provided on the cushion 50 and is spaced apart from the trim cover layer 34. The barrier layer 152 may be formed integrally with the trim cover layer 34. According to some embodiments, the trim cover layer 34 and the barrier layer 152 are bonded or sealed at intersections of the layers 34, 152 at peripheral ends (not shown) of the cushion 50.

The barrier layer 152 is disposed upon the base surface 112 of the cushion 50. The base surface 112 supports the cushion 50 upon the frame 30. The barrier layer 152 may also be formed from an air resistant layer, such as an air impermeable layer. Alternatively, the barrier layer 152 may be provided from a rigid seat pan or carrier substrate.

The porosity of the cushion 50 provides free flow paths of the fluid impermeable cushion 50. The retainer 108 extends only partially into the cushion 50 and cooperates with the trench 106 so that the trench 106 does not extend to the base layer 152. The trench 106 restricts a flow path of air in the cushion 50, but does not prevent air flow within the cushion 50 between the trench 106 and the base layer 152.

The base layer 152 is provided with an inlet 154 formed through the based surface 112 to permit a flow of fluid through the base layer 152 at the designated orientation. Although the base layer 152 may be formed from an air impermeable material, the inlet 154 permits the base layer 152 to be air permeable as defined by the inlet 154. The inlet 154 may be a vent, a port, actuated, or the like.

The base layer 152 is provided with a plurality of spaced apart outlets 156 formed through the base layer 152 to permit a flow of fluid through the base layer 152. To further assist fluid flow, and to direct the fluid flow, a fluid actuator, such as a fan assembly 158 is provided in the inlet 154 to direct the flow of air through the cushion 50. The fan assembly 158 is directed inward from the cushion assembly 150, thereby intaking air from into the cushion 50. Although the fan assembly 158 is illustrated and described, the fluid actuator may be a compressor, or the like. Likewise, the fan assembly 158 may include a heat transfer device, such as a heater or chiller, to heat or cool the air passed through the cushion 50.

In the intake orientation of the fan assembly 158, operation of the fan assembly 158 pushes external air through the inlet 154 in the base layer 152, through the cushion 50, and out of the outlets 156 as illustrated by the flow direction arrows. The open volume of the cushion 50 permits air to pass beneath the trench 106 and the retainer 108 from the inlet 154 to some of the outlets 156. Air is routed beneath the trench 106 without additional channels, outlets, fluid actuators, or the like. Such improvements increase efficiency and also reduce noise and energy.

In the intake operation of FIG. 5, the cushion 50 is over-pressured with air, as opposed to the under-pressured condition of the embodiments of FIGS. 3 and 4. When the air is heated, the vents 156 permit evacuation of the heated air from the base surface 112 away from the occupant. The filaments 52 create turbulence to assist with heat transfer by convection within the cushion 50.

According to a first clause, a cushion assembly is provided, alone or in combination with any of the successive clauses, with a cushion provided with a mesh member. The mesh member is provided with a set of filaments of polymeric material, wherein at least two members of the set of filaments are looped and bonded to each other. A fluid impermeable layer is attached to the cushion. The fluid impermeable layer is provided with an inlet and an outlet. A fluid actuator is attached to the inlet or the outlet.

According to a second clause, the cushion assembly of any of the preceding or successive clauses is provided, wherein the cushion is fluid permeable.

According to a third clause, the cushion assembly of any of the preceding or successive clauses is provided, wherein the fluid actuator is attached to the inlet to intake fluid into the cushion.

According to a fourth clause, the cushion assembly of any of the preceding or successive clauses is provided, wherein the fluid actuator is attached to the outlet to exhaust fluid from the cushion.

According to a fifth clause, the cushion assembly of any of the preceding or successive clauses is provided, wherein the cushion is provided with an occupant support surface and a base surface. The fluid impermeable layer is further provided with an occupant support layer and a base layer.

According to a sixth clause, the cushion assembly of any of the preceding or successive clauses is provided, wherein the base layer is opposed to the occupant support layer. The inlet and the outlet are formed in the base layer.

According to a seventh clause, the cushion assembly of any of the preceding or successive clauses is provided, wherein the base layer is opposed to the occupant support layer. The inlet is formed in the occupant support layer and the outlet is formed in the base layer.

According to an eighth clause, the cushion assembly of any of the preceding or successive clauses is provided, wherein the fluid impermeable layer comprises a trim layer.

According to a ninth clause, the cushion assembly of any of the preceding or successive clauses is provided, wherein the fluid impermeable layer is further provided with a barrier layer.

According to a tenth clause, the cushion assembly of any of the preceding or successive clauses is further provided with a retainer to attach the trim layer to the cushion.

According to an eleventh clause, the cushion assembly of any of the preceding or successive clauses is provided, wherein the retainer extends partially into the cushion.

According to a twelfth clause, the cushion assembly of any of the preceding or successive clauses is provided, wherein the retainer is oriented between the inlet and the outlet. The retainer attaches the trim layer to a base layer. A fluid permeable region of the cushion is oriented between the trim layer and the base layer.

According to a thirteenth clause, the cushion assembly of any of the preceding or successive clauses is provided, wherein the fluid actuator is further provided with a fan assembly.

According to a fourteenth clause, the cushion assembly of any of the preceding or successive clauses is provided, wherein the fluid actuator is further provided with a heat transfer device.

According to a fifteenth clause, the cushion assembly of any of the preceding or successive clauses is provided, wherein the fluid actuator is further provided with a heater.

According to a sixteenth clause, the cushion assembly of any of the preceding or successive clauses is provided, wherein the fluid impermeable layer is further provided with one or more fluid impermeable layers.

According to a seventeenth clause, a seat assembly is provided with a frame, and the cushion assembly of any of the preceding or successive clauses, mounted to the frame to support an occupant upon the frame.

According to an eighteenth clause, a cushion assembly is provided, alone or in combination with any of the preceding or successive clauses, with a cushion providing an occupant support surface, and a base surface. A fluid impermeable layer is attached to the cushion, the fluid impermeable layer is provided with an inlet formed in the base surface and an outlet formed in the base surface. A fluid actuator is attached to the inlet or the outlet.

According to a nineteenth clause, the cushion assembly of any of the preceding or successive clauses is provided, wherein the cushion is provided with a mesh member. The mesh member is provided with a set of filaments of polymeric material, wherein at least two members of the set of filaments are looped and bonded to each other.

According to a twentieth clause, the cushion assembly of any of the preceding or successive clauses is provided, wherein the cushion is provided with a spacer fabric.

According to a twenty-first clause, a cushion assembly is provided, alone or in combination with any of the preceding or successive clauses, with a cushion. A fluid impermeable layer is attached to the cushion. The fluid impermeable layer is provided with an inlet and an outlet. A retainer is connected to the fluid impermeable layer and the cushion, and the retainer extends into a fluid permeable region of the cushion between the inlet and the outlet.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A cushion assembly comprising:
a cushion comprising a mesh member, the mesh member comprising a set of filaments of polymeric material, wherein at least two members of the set of filaments are looped and bonded to each other;
a fluid impermeable layer attached to the cushion, the fluid impermeable layer comprising an inlet and an outlet; and
a fluid actuator attached to the inlet or the outlet.

2. The cushion assembly of claim 1, wherein the cushion is fluid permeable.

3. The cushion assembly of claim 1, wherein the fluid actuator is attached to the inlet to intake fluid into the cushion.

4. The cushion assembly of claim 1, wherein the fluid actuator is attached to the outlet to exhaust fluid from the cushion.

5. The cushion assembly of claim 1, wherein the cushion comprises an occupant support surface and a base surface; and
wherein the fluid impermeable layer further comprises an occupant support layer and a base layer.

6. The cushion assembly of claim 5, wherein the base layer is opposed to the occupant support layer; and
wherein the inlet and the outlet are formed in the base layer.

7. The cushion assembly of claim 5, wherein the base layer is opposed to the occupant support layer; and
wherein the inlet is formed in the occupant support layer and the outlet is formed in the base layer.

8. The cushion assembly of claim 1, wherein the fluid impermeable layer comprises a trim layer.

9. The cushion assembly of claim 1, wherein the fluid impermeable layer comprises a barrier layer.

10. The cushion assembly of claim 1, further comprising a retainer to attach the trim cover to the cushion.

11. The cushion assembly of claim 10, wherein the retainer extends partially into the cushion.

12. The cushion assembly of claim 10, wherein the retainer is oriented between the inlet and the outlet;
wherein the retainer attaches the trim layer to a base layer; and
wherein a fluid permeable region of the cushion is oriented between the trim cover and the base layer.

13. The cushion assembly of claim 1, wherein the fluid actuator comprises a fan assembly.

14. The cushion assembly of claim 1, wherein the fluid actuator further comprises a heat transfer device.

15. The cushion assembly of claim 1, wherein the fluid impermeable layer further comprises one or more fluid impermeable layers.

16. A seat assembly comprising:
a frame; and
the cushion assembly of claim 1, mounted to the frame to support an occupant upon the frame.

17. A cushion assembly comprising:
a cushion comprising an occupant support surface, and a base surface;
a fluid impermeable layer attached to the cushion, the fluid impermeable layer comprising an inlet formed in the base surface and an outlet formed in the base surface; and
a fluid actuator attached to the inlet or the outlet.

18. The cushion assembly of claim 17, wherein the cushion comprises a mesh member, the mesh member comprising a set of filaments of polymeric material, wherein at least two members of the set of filaments are looped and bonded to each other.

19. The cushion assembly of claim 18, wherein the cushion comprises spacer fabric.

20. A cushion assembly comprising:
a cushion;
a fluid impermeable layer attached to the cushion, the fluid impermeable layer comprising an inlet and an outlet; and
a retainer connected to the fluid impermeable layer and the cushion, and extending into a fluid permeable region of the cushion between the inlet and the outlet.
